(19) United States
(12) Patent Application Publication
(10) Pub. No.: US 2011/0254835 A1
(43) Pub. Date: Oct. 20, 2011

(54) SYSTEM AND METHOD FOR THE CREATION OF 3-DIMENSIONAL IMAGES

(75) Inventor: Edo Segal, New York, NY (US)

(73) Assignee: Futurity Ventures LLC, White Plains, NY (US)

(21) Appl. No.: 13/088,609

(22) Filed: Apr. 18, 2011

Related U.S. Application Data
(60) Provisional application No. 61/325,968, filed on Apr. 20, 2010.

(51) Int. Cl. G06T 15/00

(52) U.S. Cl. 345/419

(57) ABSTRACT

The invention relates to a method and system for generating a 3-dimensional image on a 2-dimensional display of a device. The method includes the steps of receiving an image in image processor means and using the image processor means to determine at least two pixels layers in the image. A proximity value is then assigned to each pixel layer wherein the proximity value is indicative of a depth perception of the pixel layer relative to a user of a device having a display screen. An instruction module is then coupled to the image operative to cause each pixel layer to move along an axis of orientation on the 2-dimensional display of the device and at a velocity rate dependent upon the proximity value assigned to the pixel layer.

### CROSS REFERENCE TO RELATED APPLICATIONS

This patent application claims the benefit of priority under 35 U.S.C. Section 119(e) from U.S. Provisional Application Ser. No. 61/325,968, filed on Apr. 20, 2010, which is hereby incorporated by reference as if set forth in its entirety herein.

### FIELD OF THE INVENTION

This invention relates generally to the field of image processing and more particularly to the creation and presentation of 3-dimensional (3-D) images on a 2-dimensional viewing surface.

### BACKGROUND OF THE INVENTION

Since the invention of the stereoscope in 1847, there has been a desire for emulating the 3-D images instead of being content with two dimensional images which lack realism due to the absence of depth cues. Various techniques have been devised and developed for producing 3-D images, each varying in degree of success and quality of image. These techniques generally belong to two major classes, namely the autostereoscopic imaging class which produces 3-D images which can be viewed freely without spectacles, and the binocular stereoscopic imaging class which produces 3-D images which requires observers to wear spectacles or viewers. Techniques of the later class have been used in 3-D movies from the 1950's and in occasional 3-D image productions such as used in children books.

Color separation of stereo images has been utilized for over fifty years in the production of photographs, 3D movies and the printed page. Typically, stereo images are separated by mutually extinguishing filters such as a blue-green lens filter over one eye and a red filter over the other eye. With this combination, a full true color image is not obtained, and this color combination may cause eye fatigue, and color suppression.

Prints, drawings or representation that yield a 3-D image when viewed through appropriately colored lenses are called anaglyphs.

An anaglyph is a picture generally consisting of two distinctly colored, and preferably, complementary colored, prints or drawings. The complementary colors conventionally chosen for commercial printings of comic books and the like are orange and blue-green. Each of the complementary colored prints contains all elements of the picture. For example, if the picture consists of a car on a highway, then the anaglyph will be imprinted with an orange car and highway, and with a blue-green car and highway. For reasons explained below, some or all of the orange colored elements of the picture are horizontally shifted in varying amounts in the printing process relative to their corresponding blue-green elements.

An anaglyph is viewed through glasses or viewers having lenses tinted about the same colors used to prepare the anaglyph. While orange and blue-green lenses are optimally used with an orange and blue-green anaglyph, red and blue lenses work satisfactorily in practice and apparently are conventionally used.

Thus, the prior art generally required complex specialized equipment for the transmission of 3-dimensional images. This inhibited the use of 3-D technology because much capital investment has been devoted to equipment for handling regular 2-dimensional images. It would be desirable to utilize 2-dimensional display equipment to produce 3-dimensional images.

### SUMMARY OF THE INVENTION

In accordance with certain illustrated embodiments of the invention, disclosed is a method and system for generating a 3-dimensional image on a 2-dimensional display of a device. The method includes the steps of receiving an image in image processor means and using the image processor means to determine two or more pixels layers in the image. A proximity value is then assigned to each pixel layer wherein the proximity value is indicative of a depth perception of the pixel layer relative to a user of a device having a display screen. An instruction module is then coupled to the image operative to cause each pixel layer to move along an axis of orientation on the 2-dimensional display of the device and at a velocity rate dependent upon the proximity value assigned to the pixel layer when the device is caused to move along an axis of rotation. Thus, the resulting image displayed on the 2-dimensional display of the device (e.g., an iPhone or iPad) appears as a moving 3-dimensional image relative to the perspective of a user viewing the image on the device as the device is caused to move.

These and other aspects, features, and advantages can be appreciated from the accompanying description of certain embodiments of the invention and the accompanying drawing figures.

### BRIEF DESCRIPTION OF THE DRAWINGS

The objects and features of the invention can be understood with reference to the following detailed description of certain embodiments of the invention taken together in conjunction with the accompanying drawings in which:

FIG. 1 is a block diagram of a computer system that can be used with certain embodiments of the invention;

FIG. 2 is a flow diagram depicting the method of certain embodiments of the invention;

FIG. 3 illustrates an image which is to be transformed to a 3-dimensional image on a 2-dimensional device shown in FIG. 4; and

FIG. 4 is a system diagram illustrating system components of certain embodiments of the invention.

### WRITTEN DESCRIPTION OF CERTAIN EMBODIMENTS OF THE INVENTION

The present invention is now described more fully with reference to the accompanying drawings, in which an illustrated embodiment of the invention is shown. The invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting the invention, but rather are provided as a representative embodiment for teaching one skilled in the art one or more ways to implement the invention. Furthermore, the terms and phrases used herein are not intended to be limiting, but rather are to provide an understandable description of the invention.

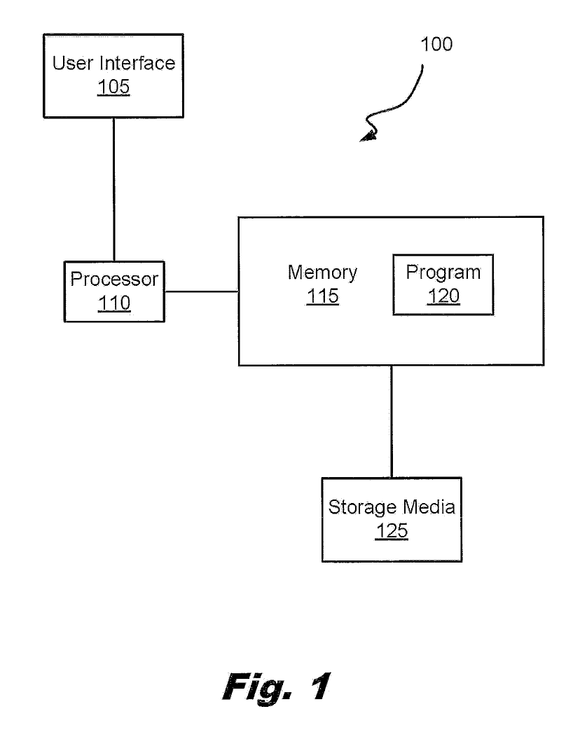

It is to be appreciated that the embodiments of this invention as discussed below may be incorporated as a software algorithm, program or code residing in firmware and/or on computer useable medium (including software modules and browser plug-ins) having control logic for enabling execution on a computer system having a computer processor. Such a computer system typically includes memory storage configured to provide output from execution of the computer algorithm or program. An exemplary computer system is shown as a block diagram in FIG. 1 depicting computer system 100. Although system 100 is represented herein as a standalone system, it is not limited to such, but instead can be coupled to other computer systems via a network (not shown) or encompass other embodiments as mentioned below. System 100 preferably includes a user interface 105, a processor 110 (such as a digital data processor), and a memory 115. Memory 115 is a memory for storing data and instructions suitable for controlling the operation of processor 110. An implementation of memory 115 can include a random access memory (RAM), a hard drive and a read only memory (ROM), or any of these components. One of the components stored in memory 115 is a program 120.

Program 120 includes instructions for controlling processor 110. Program 120 may be implemented as a single module or as a plurality of modules that operate in cooperation with one another. Program 120 is contemplated as representing a software embodiment, or a component or module thereof, of the method 200 described hereinbelow.

User interface 105 includes an input device, such as a keyboard, touch screen, tablet, or speech recognition subsystem, for enabling a user to communicate information and command selections to processor 110. User interface 105 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 110. In embodiments of the present invention, the program 120 can execute entirely without user input or other commands based on programmatic or automated access to a data signal flow through other systems that may or may not require a user interface for other reasons.

While program 120 is indicated as already loaded into memory 115, it may be configured on a storage media 125 for subsequent loading into memory 115. Storage media 125 can be any conventional storage media such as a magnetic tape, an optical storage media, a compact disc, or a floppy disc. Alternatively, storage media 125 can be a random access memory, or other type of electronic storage, located on a remote storage system, such as a server that delivers the program 120 for installation and launch on a user device.

It is to be understood that the invention is not to be limited to such a computer system 100 as depicted in FIG. 1 but rather may be implemented on a general purpose microcomputer incorporating certain components of system 100, such as one of the members of the Sun® Microsystems family of computer systems, one of the members of the IBM® Personal Computer family, one of the members of the Apple® Computer family, or a myriad of other computer processor driven systems, including a: workstations, desktop computers, laptop computers, netbook computers, an iPad™ or like tablet device, a personal digital assistant (PDA), or a smart phone or other like handheld devices.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be described in a general context of computer-executable instructions, such as program modules, being executed by a computer. Generally, program modules include routines, programs, objects, components, data structures, etc., that perform particular tasks or implement particular abstract data types.

With the exemplary computing system environment 100 of FIG. 1 being generally shown and discussed above, the method and system of the invention in accordance with illustrated embodiments will now be discussed. It is to be appreciated that the method described herein has been indicated in connection with a flow diagram for facilitating a description of the principal processes of an illustrated embodiment of the invention; however, certain blocks can be invoked in an arbitrary order, such as when the events drive the program flow such as in an object-oriented program. Accordingly, the flow diagram is to be understood as an example flow and that the blocks can be invoked in a different order than as illustrated.

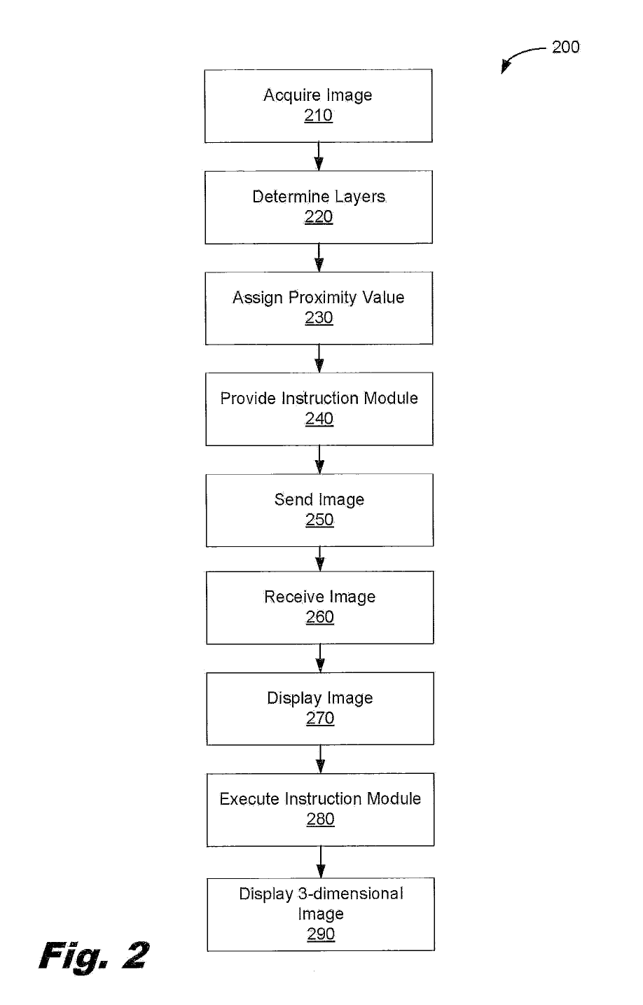

With reference now to FIG. 2, a method 200 describing the conversion of a 2D image to a 3D image when displayed on preferably a handheld device having a 2-dimensional display will now be discussed.

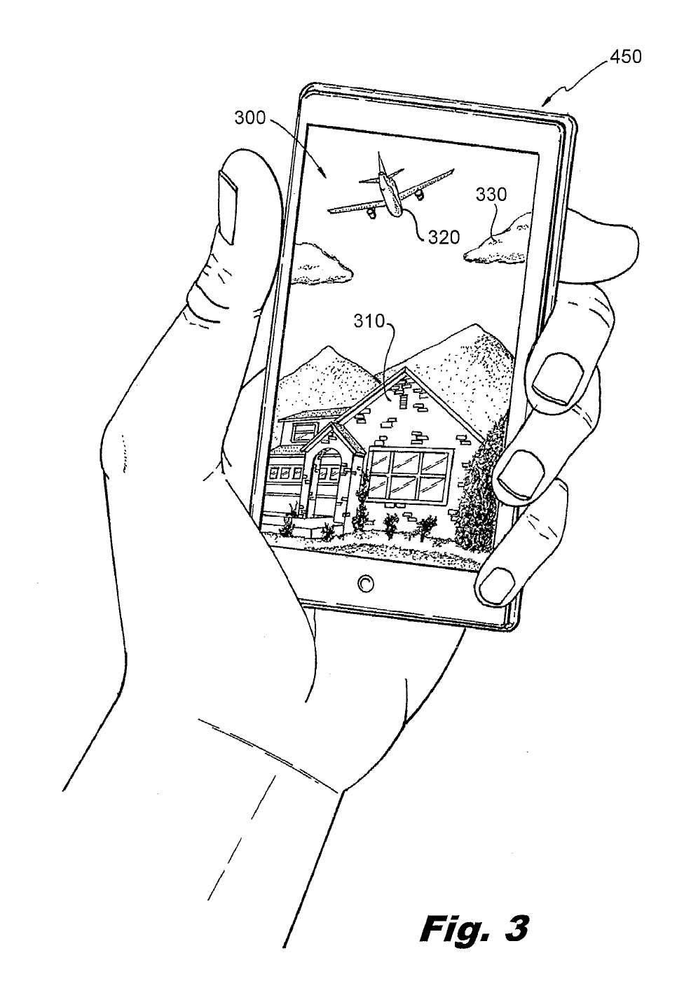

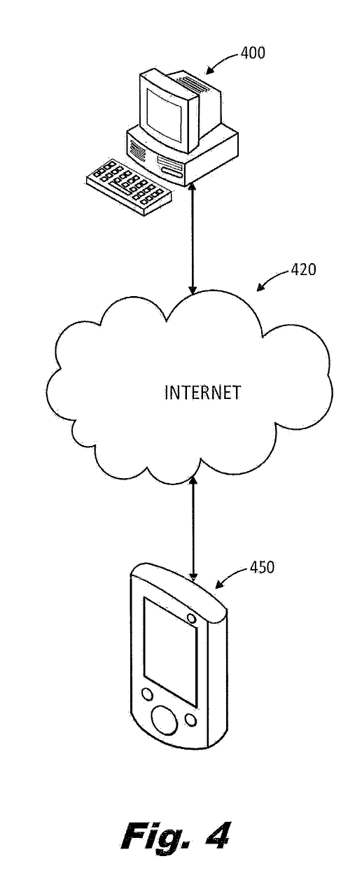

First a graphic image 300 (FIG. 3) is captured by processor system 400 (FIG. 4) executing method 200 to convert a 2D image as represented by image 300 to appear as a 3D image on a handheld device 450 (FIG. 4) (step 210). It is to be appreciated that the graphic image 300 can consist of virtually any type of recognized image file format used to file photographic and other images, including for example, JPEG/JIFF, Exif, TIFF, RAW, PNG, GIF, BMP, PPM, PGM, PBM, PNM and the like.

Next, processor system 400, preferably through user input, identifies and determines the various image layers in image 300 (step 220). For purposes of the invention, layers are to be understood to separate different elements of an image according to a depth perspective of a user. For instance, a layer can be compared to a transparency which imaging effects or images are applied and placed over or under an image representing a part of a picture, preferably as pixels. They are stacked on top of each other, and depending on the order, determine the appearance of the final picture. It may be understood as containing just a picture which can be superimposed on another one. For example, with reference to the image 300 of FIG. 3, three discrete pixel layers are defined by system 400, namely: first 310, second 320 and third 330 layer.

Each aforesaid layer of image 300 is then assigned a proximity value dependent upon the depth perception of each layer (310-330) relative to the other layers as dependent upon a viewer's perceived depth perception of the entire image 300 (step 230). For example, with reference to FIG. 3, first layer 310 (e.g., the house) is assigned a first proximity value as it is determined to be closest to a viewer's depth perception of image 300, the second layer 320 (e.g., the plane) is assigned a second proximity value determined to be closer to a viewers depth perception than succeeding layers (i.e., third layer 330) but further than preceding layers (i.e., first layer 310). The last layer, third layer 330 (e.g., the background), is assigned a last proximity value, or in this instance, a third proximity value as it is determined to be furthest from a user's depth perception of image 300. Thus, it is to be understood that in accordance with the illustrated embodiment of the invention, each determined layer of an image (step 220) is assigned a proximity value determined to be closer to a viewers depth perception than succeeding layers but further than preceding layers.

An instruction module is then preferably coupled/embedded with image 300. This instruction module contains software code and/or instructions operative to facilitate movement of each determined layer (310-330) when image 300 is viewed on a display of a device 450 providing a 3D appearance for image 300 to the user of device 450, as discussed further below (step 240). It is to be appreciated the instruction module can include java script, active x, component object model, object linking embedding or any other software code/instructions providing the below discussed functionality for providing a 3D appearance for image 300 when displayed on a 2-dimensional display of a handheld device 450.

Once the image 300 is processed in accordance with the above (steps 210-240), the image 300 is sent from system 400 to a handheld device 450 through any known applicable transmission techniques. For descriptive purposes of the illustrated embodiment of the invention, handheld device 450 is to be understood to be PDA device, a smartphone device such as the Apple iPhone™, or a tablet device such as the iPad™ device, each preferably having an accelerometer (or like component) for detecting movement of the device 450 along an axis of orientation defined by device 450. Preferably, a processed image 300 is sent from system 400 to device 450, via the internet 410, using know transmission protocol techniques. It is to be understood the system 400 is not to be understood to be limited to sending a single image to a single handheld device. But rather it is to be understood that system 400 may be connected to an internet server configured to send a plurality of processed images to a plurality of handheld devices in accordance with the certain illustrated embodiments of the invention.

Device 450 then receives the processed image 300 therein (step 260). When a user of device 450 causes image 300 to be displayed on the display screen of device 450 (step 270), the embedded instruction module of image 300 is caused to execute via the processing means of device 450 (step 280). Execution of the software module embedded in the processed image 300 causes each aforesaid layer (310-330) defined in image 300 (step 220) to move at a different velocity rate relative to one another on the display screen of device 450 when device 450 is caused to move along an axis of orientation as detected by the device's 450 accelerometer (or other like component) for detecting movement of a handheld device (step 290). Preferably, each image layer (310-330) moves along the axis of orientation of device 450 at a velocity rate dependent upon its determined proximity value (step 230). That is, the image layer having a proximity value closest to a user's determined depth perception (e.g., layer 310) moves at a velocity greater than each succeeding proximity value for the other succeeding image layers (e.g., layers 320 and 330) when the device is caused to move. This varied rate of movement for each determined layer in image 300 provides a 3D representation of image 300 to a user of device 450 who is viewing the image 300 on the 2-dimensional display screen of device 450. It is to be appreciated that so long as image 300 is displayed on the display screen of device 450, the embedded instruction module of image 300 causes the processor means of device 450 to facilitate movement of each determined image layer of image 300 as device 450 is caused to move as detected by its accelerometer 450 component, as described above.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the scope of the present invention.

What is claimed is:

1. A computer implemented method for generating a 3-dimensional image at a computing device, the computing device having a processor and a memory accessible by the processor, the method comprising:
receiving an image at the memory, the image having one or more elements;
processing the image with the processor to identify at least one pixel layer within the image, the pixel layer corresponding to at least one element;
assigning a proximity value to the pixel layer, the proximity value corresponding to a depth perception of the image;
coupling an instruction module with the image, the instruction module containing one or more instructions that facilitate movement of the pixel layer based on the proximity value.

2. The method of claim 1, wherein the image is a 2-dimensional image.

3. The method of claim 1, wherein the image is a digital image.

4. The method of claim 1, wherein the processing step includes processing the image and a user input with the processor to identify at least one pixel layer within the image based on the user input, the pixel layer corresponding to at least one element.

5. A computer implemented method for generating a 3-dimensional image at a computing device, the computing device having a processor and a memory accessible by the processor, the method comprising:
receiving an image at the memory, the image having one or more elements;
processing the image with the processor to identify a plurality of pixel layers within the image, each of the pixel layers corresponding to at least one element;
assigning a respective proximity value to each of the pixel layers, the respective proximity value corresponding to a depth perception of the image; and
coupling an instruction module with the image, the instruction module containing one or more instructions that facilitate movement of each of the pixel layers based on the respective proximity value of each of the pixel layers.

6. The method of claim 5, further comprising:
executing the instruction module at the processor;
based on the execution of the instruction module, causing a first pixel layer to move at a first velocity rate while a second pixel layer moves at a second velocity rate.

7. The method of claim 6, wherein the computing device further has a movement detector.

8. The method of claim 7, wherein the first velocity rate and the second velocity rate are dictated by the movement detector.

9. A system for generating a 3-dimensional image, the system comprising:
a processor;
a memory accessible by the processor; and
one or more software modules encoded in the memory which execute an image conversion application in the processor;
wherein the image conversion application, when executed by the processor, configures at least one of the processor and the memory to:
receive an image at the memory, the image having one or more elements;
process the image with the processor to identify a plurality of pixel layers within the image, each of the pixel layers corresponding to at least one element;
assign a respective proximity value to each of the pixel layers, the respective proximity value corresponding to a depth perception of the image; and
couple an instruction module with the image, the instruction module containing one or more instructions that facilitate movement of each of the pixel layers based on the respective proximity value of each of the pixel layers.

10. The system of claim 9, wherein the image conversion application, when executed by the processor, further configures at least one of the processor and the memory to:
execute the instruction module at the processor;
based on the execution of the instruction module, cause a first pixel layer to move at a first velocity rate while a second pixel layer moves at a second velocity rate.

11. The system of claim 10, further comprising a movement detector communicatively connected to the processor, the movement detector having an axis of orientation.

12. The system of claim 11, wherein the first velocity rate and the second velocity rate are dictated by the movement detector about the axis of orientation.

13. The system of claim 10, wherein the first pixel layer is superimposed upon the second pixel layer.

14. The system of claim 10, further comprising a display communicatively connected to the processor.

15. The system of claim 14, wherein the display is a 2-dimensional display.

16. The system of claim 14, wherein the display displays at least one of a movement of the first pixel layer and a movement of the second pixel layer.
